(19) United States
(12) Patent Application Publication
(10) Pub. No.: US 2026/0357621 A1
(43) Pub. Date: Nov. 12, 2026

(54) LATCH FOR FRONT HOOD OF VEHICLE

(71) Applicant: Kiekert AG, Heiligenhaus (DE)

(72) Inventors: Pingchun HE, Changshu, Suzhou, Jiangsu (CN); Shengjie TANG, Changshu, Suzhou, Jiangsu (CN); Xuanlang WANG, Changshu, Suzhou, Jiangsu (CN)

(73) Assignee: Kiekert AG, Heiligenhaus (DE)

(21) Appl. No.: 19/131,987

(22) PCT Filed: Nov. 27, 2023
(86) PCT No.: PCT/CN2023/134400

§ 371 Date: May 22, 2025

(30) Foreign Application Priority Data
Nov. 28, 2022 (CN) 202223253462.3

(51) Int. Cl. E05B 83/24; E05B 77/36; E05B 85/02; E05B 85/24

(52) U.S. Cl. CPC E05B 83/24; E05B 77/36; E05B 85/02; E05B 85/245

(57) ABSTRACT

A front hood latch of a vehicle is provided. The latch includes a housing (1) fixed to a vehicle body, and a catch (2), a pawl (3) and an auxiliary catch (4) which are rotatably supported on the housing (1). The catch (2) is configured to lock a striker, and the pawl (3) is configured to lock the catch (2). The auxiliary catch (4) and the catch (2) are configured to abut against the striker (5) at opposite sides in a locked state of the striker. The latch further includes a spacer (6) provided between the auxiliary catch (4) and the catch (2). Noise generated by wobbling of the striker within the catch can be avoided, non-smooth relative movement between the catch and the auxiliary catch, caused by machining errors, or by entry of foreign contaminants between them, can be prevented, and wear of the auxiliary catch and the catch can be reduced.

### TECHNICAL FIELD

The present disclosure relates to a latch for a front hood of a vehicle, for locking or releasing the hood by holding or releasing a striker attached thereto.

### BACKGROUND

A front hood of a vehicle, such as a hood of an engine compartment in a motor vehicle or a hood of a front trunk compartment in a new energy vehicle, is provided with a front hood latch for locking the hood to the body of the front compartment. A latch for a front hood of this type generally includes a housing provided with a striker slot, a catch mounted on the housing and configured to engage a striker attached to the hood, and a pawl for engaging the catch to keep it in a locked position. When the front hood falls down, the striker attached to the hood enters the striker slot and contacts the catch to rotate the catch into a locked position, where the catch is engaged with the pawl, thereby keeping the catch and, in turn, the striker in the locked position.

At the engaging area of the catch and the striker, a locking groove of the catch for engaging the striker has a larger dimension than that of the striker. Thus there is a gap between the catch and the striker. After the hood is closed, the gap between the catch and the striker results in wobbling of the striker in the locking groove during vibration of the vehicle body and thus results in noise.

In addition, how to ensure smooth operation for the parts in the latch, to reduce wear and extend service life of the latch are problems consistently to be solved in the field.

### SUMMARY OF THE DISCLOSURE

The present disclosure aims to solve at least one of the above problems and/or other problems existing in the prior art.

According to one aspect of the present disclosure, a latch for a front hood of a vehicle is provided for locking or releasing the hood by holding or releasing a striker attached to the hood, the latch comprises a housing fixed to a vehicle body, a catch rotatably supported on the housing and configured to lock the striker, a pawl rotatably supported on the housing and configured to lock the catch, an auxiliary catch rotatably supported on the housing, the auxiliary catch and the catch being configured to respectively abut against the striker on opposite sides in a locked state of the striker, and a spacer provided between the auxiliary catch and the catch.

By providing the auxiliary catch, the striker is clamped by the auxiliary catch and the catch on opposite sides in the locked state, thereby preventing wobbling of the striker and noise generated by the wobbling. In the double-catch solution including the catch and the auxiliary catch, a precise and slight relative movement between the two catches is required, so that the stopping portion of the auxiliary catch protrudes into the locking groove of the catch in the locked state of the striker and the striker is clamped by the stopping portion and the catch on opposite sides respectively. Therefore, there exists a high requirement for the relative movement between the catch and the auxiliary catch. The spacer can avoid non-smooth relative movement between the catch and the auxiliary catch caused by machining errors of the catch or the auxiliary catch, or by foreign contaminants between them, so as to ensure a smooth rotation of the auxiliary catch relative to the catch. Furthermore, the spacer can reduce the wear of the auxiliary catch and the catch, and hence prolong the service life of the latch.

According to an exemplary configuration, the catch and the auxiliary catch are pivotally supported on the housing through a first shaft provided on the housing, wherein the spacer is provided with a first hole for the first shaft to pass through.

According to an exemplary configuration, one of the catch and the auxiliary catch is provided with a projecting pin, and the other is correspondingly provided with a hole matched with the pin and having an inner diameter larger than an outer diameter of the pin, wherein the spacer is provided with a second hole for the pin to pass through. In this way, the spacer can be reliably held between the auxiliary catch and the catch.

According to an exemplary configuration, the latch further comprises an auxiliary locking member pivotally supported on the housing through a second shaft, wherein a first gasket is arranged between the auxiliary locking member and the housing.

Due to the first gasket provided between the auxiliary locking member and the housing, non-smooth rotation of the auxiliary locking member and wear of relevant components of the latch, caused by foreign contaminants such as dust entering the gap between the auxiliary locking member and the housing, can be avoided.

According to an exemplary configuration, the second shaft includes a main body matched with a hole of the auxiliary locking member and a step portion projecting radially from the main body at a side away from the housing, wherein a second gasket is provided between the step portion and the auxiliary locking member.

The second gasket further avoids non-smooth rotation of the auxiliary locking member and wear of related components of the latch caused by foreign contaminants such as dust entering the gap between the second shaft and the auxiliary locking member.

According to an exemplary configuration, the first gasket and/or the second gasket are configured as an annular member with an inner flange which is engaged between the auxiliary locking member and the main body, wherein an annular main body of the first gasket is engaged between the auxiliary locking member and the housing, and an annular main body of the second gasket is engaged between the step portion and the auxiliary locking member.

The first gasket and the second gasket, each designed as an annular member structure with an flange, fills radial and axial gaps between the second shaft and the auxiliary locking member, and radial and axial gaps between the auxiliary locking member and the housing, thus comprehensively reducing the risk of non-smooth movement and wear of related components caused by entry of foreign contaminants such as dust.

According to an exemplary configuration, the first gasket and/or the second gasket are made of a self-lubricating material, thus avoiding unsmooth operation of the auxiliary locking member, the second shaft or the housing caused by wear of grease or coating thereon, and avoiding wear of related components.

According to an exemplary configuration, the first gasket and the second gasket have the same structure, thus it is not necessary to distinguish between them during assembling, which is convenient for assembling, and non-smooth movement of the auxiliary locking member due to asymmetric wear can be prevented.

According to an exemplary configuration, the spacer is made of plastic. The plastic spacer arranged between, for example, a metal catch and a metal auxiliary catch helps to reduce the wear of the catch and the auxiliary catch.

According to an exemplary configuration, the auxiliary catch comprises a first stopping portion and a second stopping portion located at opposite sides of the striker in the locked state of the striker, wherein the first stopping portion and the catch abut against the striker on opposite sides, respectively. In the case that the front hood of the vehicle, due to a collision, has an unexpected opening tendency, the second stopping portion stops unexpected movement of the striker, thus avoiding the unexpected opening of the front hood and improving the strength of the latch.

### BRIEF DESCRIPTION OF THE DRAWINGS

FIG. 1 shows a schematic perspective view of a latch for a front hood of a vehicle according to an exemplary embodiment of the present disclosure.

FIG. 2 shows a schematic front view of the latch in an unlocked state, in which the spring is shown in a simplified manner.

FIG. 3 shows a schematic front view of the latch in a locked state, in which the spring is shown in a simplified manner.

FIG. 4 shows a schematic exploded view of a double catch assembly of the latch.

FIG. 5 shows a schematic perspective view of the latch shown in FIG. 1, seen from another direction, in which an operating lever and an auxiliary locking member are shown.

FIG. 6 shows a partial sectional view of the auxiliary locking member mounted to the housing of the latch.

### DETAILED DESCRIPTION

Embodiments of the present disclosure are described hereinafter with reference to the drawings. In the following description, many details are set forth in order to enable those skilled in the art to better understand and implement the present disclosure. However, it is obvious to those skilled in the art that the implementation of the present disclosure may not need some of the details.

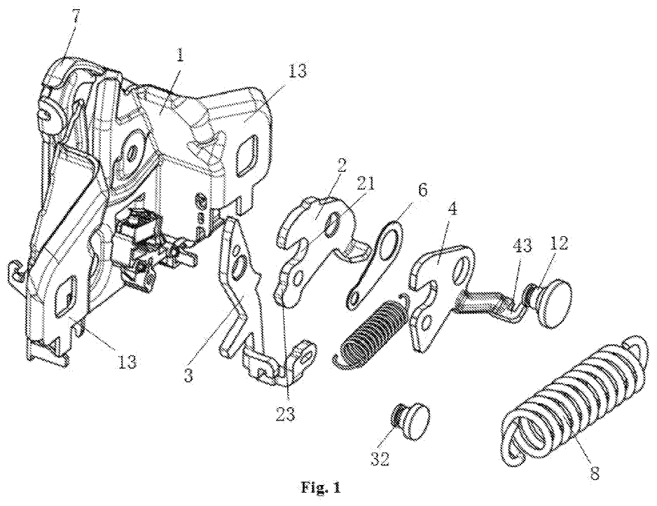

Referring to FIGS. 1-5, a schematic view of a latch for a front hood of a vehicle according to an exemplary embodiment of the present disclosure is shown. The front hood of the vehicle described herein includes but is not limited to, a hood of an engine compartment of a motor vehicle. For example, for new energy vehicles, a trunk compartment is provided at corresponding front portion of the vehicle, and the latch of the present disclosure can also be applied to the hood of the trunk compartment. The front compartment of the vehicle can be opened or closed by the front hood (not shown), to which a striker 5 is attached. The latch is fixed to the vehicle body (not shown) of the front compartment, and holds the front hood in a closed position by locking the striker 5.

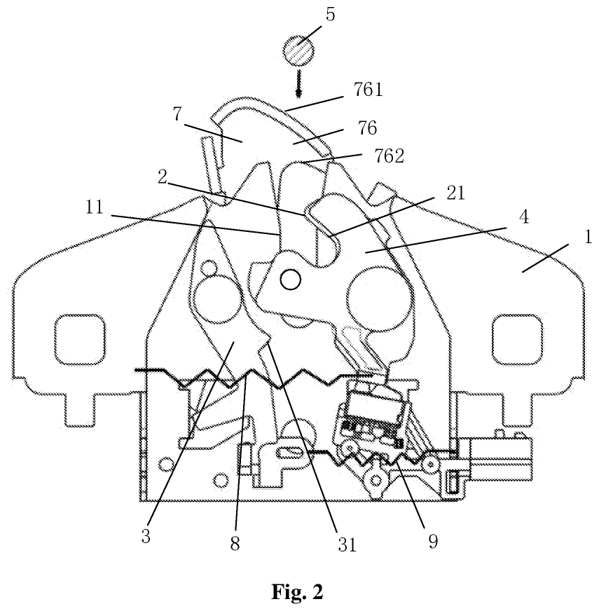

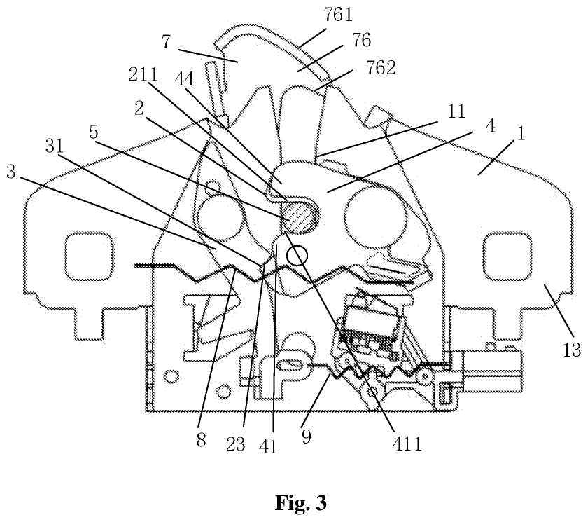

As shown in FIG. 1, the latch includes a housing 1, a catch 2, a pawl 3, an auxiliary catch 4, a first spring 8 and a second spring 9. As shown in FIG. 1, the housing 1 includes mounting portions 13, through which the latch is fixed to the vehicle body. As shown in FIGS. 2, 3 and 5, a striker slot 11 for holding the striker 5 is formed in the housing 1. As shown in FIG. 1, the catch 2 is pivotally supported on the housing 1 through a first shaft 12 provided (for example, by riveting) on the housing 1. In the embodiment shown in FIGS. 1-5, the catch 2 is located on the right side of the striker slot 11 of the housing 1. However, the catch may also be arranged on the left side of the striker slot 11. The catch 2 is provided with a locking groove 21 for locking the striker 5. The catch 2 can be rotated between an unlocked position shown in FIG. 2 and a locked position shown in FIG. 3. In the locked position shown in FIG. 3, the striker 5 is confined in the locking groove 21 and the striker slot 11, and cannot exit from the striker slot 11. Preferably, each of the first shaft 12 and a second shaft 71 and a third shaft 32 (described below) may be a rivet connected to the housing 1 by riveting.

The pawl 3 is pivotally supported on the housing 1 via the third shaft 32, on the side (the left side in FIGS. 2 and 3) of the striker slot 11 opposite to the catch 2. As shown in FIG. 3, the pawl 3 is provided with a first engaging portion 31 for abutting against the second engaging portion 23 of the catch 2 to prevent the catch 2 from rotating in the unlocking direction (clockwise in FIG. 3), thereby locking the catch 2 which holds the striker 5. As shown schematically in FIGS. 2 and 3, one end of the second spring 9 is connected to the lower end of the pawl 3, and the other end is connected to the housing 1. The pawl 3 is biased toward the locked position by the second spring 9. Exemplarily, the pawl 3 may be coupled to an actuating lever (not shown) and rotated in clockwise direction in FIG. 3 in response to the operation of the actuating lever, so that the first engaging portion 31 is disengaged from the second engaging portion 23 of the catch 2 to release the catch 2 from the locked position.

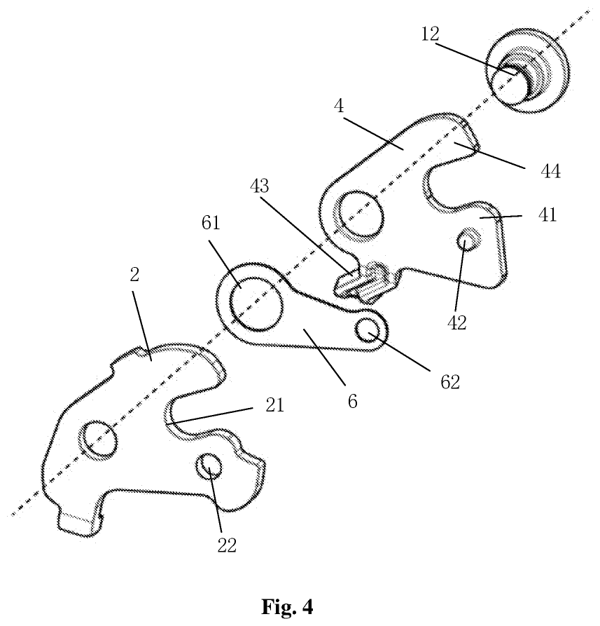

In the example shown in FIGS. 1-5, the auxiliary catch 4 is arranged between the catch 2 and the vehicle body, and is pivotally supported on the housing 1 through the first shaft 12 so as to be rotated coaxially with the catch 2. A protrusion 43 is formed on the auxiliary catch 4.One end of the first spring 8 is connected to the protrusion 43, and the other end is connected to the housing 1. The first spring 8 biases the auxiliary catch 4 towards the unlocked position (in the clockwise direction in FIG. 3). As shown in FIGS. 1 and 4, the auxiliary catch 4 is provided with a pin 42 projecting towards the catch 2, and the catch 2 is correspondingly provided with a hole 22 matched with the pin 42. It can be understood by those skilled in the art that a pin may also be provided on the catch 2 and a hole may be provided on the auxiliary catch 4. Through the cooperation of the pin and the hole, the movement of the catch 2 is related to the movement of the auxiliary catch 4 in a double catch assembly. Specifically, after the striker 5 enters into the striker slot 11 and then into the locking groove 21 of the catch 2 in the unlocked position as shown in FIG. 2, it continues to move towards the bottom of the striker slot 11 and presses against the lower side wall of the locking groove 21, so that the catch 2 is rotated towards the locked position. Meanwhile, due to the pin 42 on the auxiliary catch 4 located in the hole 22, the rotation of the catch 2 carries the auxiliary catch 4 to rotate together, towards the locked position shown in FIG. 3. During the rotation of the auxiliary catch 4, the first spring 8 is stretched. Further, since the inner diameter of the hole 22 is larger than the outer diameter of the pin 42, the pin 42 can move in the hole 22, and there may be a small relative rotation between the catch 2 and the auxiliary catch 4. After the catch 2 is rotated to the locked position abutting against the pawl 3, due to the action of the first engaging portion 31 of the pawl 3, the catch 2 can no longer rotate to the unlocked position, while the auxiliary catch 4, due to the force of the first spring 8, can rotate to the unlocked position (in the clockwise direction in FIG. 3) relative to the catch 2, so that the side wall of the first stopping portion 41 protrudes into the locking groove 21. The stopping portion 41 abuts against the striker 5 from the lower side as shown in FIG. 3, and the upper wall of the locking groove 21 of the catch 2 abuts against the striker 5 from the upper side, thereby clamping the striker 5 therebetween. By providing the auxiliary catch 4, the striker is clamped by auxiliary catch and the catch on opposite sides in the locked state, thus wobbling of the striker is prevented and noise generated by the wobbling is further eliminated.

A precise and slight relative movement between the catch and the auxiliary catch is required. However, non-smooth relative movement between the catch and the auxiliary catch may be caused by machining errors of the catch or the auxiliary catch, or by foreign contaminants, dust accumulation or corrosion between them, and as a result, the auxiliary catch cannot rotate to a desired position, causing the auxiliary catch to be unable to prevent the striker from wobbling or reduce noise. Therefore, as shown in FIG. 4, a spacer 6 is provided between the auxiliary catch 4 and the catch 2. The provision of the spacer can prevent non-smooth relative movement between the catch and the auxiliary catch caused by machining errors of the catch or the auxiliary catch, or foreign contaminants, dust accumulation or corrosion between them, etc, so as to ensure that the auxiliary catch 4 can rotate smoothly relative to the catch 2. Furthermore, the spacer 6 can reduce the wear of the auxiliary catch and the catch and prolong the service life of the lock.

Preferably, the spacer may be a wear-resistant plastic spacer. Plastic here is a material known in the art. In the illustrated example, a first hole 61 through which the first shaft 12 passes and a second hole 62 through which the pin 42 passes are formed in the spacer 6. In this way, the spacer can be reliably held between the auxiliary catch 4 and the catch 2.

As shown in FIGS. 3 and 4, the auxiliary catch 4 includes a first stopping portion 41 and a second stopping portion 44 located at opposite sides of the striker 5 in the locked state. Since the striker 5 can be retained at both the upper and the lower sides, the strength of the latch can be significantly improved. For example, in the case that the front hood of the vehicle, due to a collision, has an unexpected opening tendency, the front hood tends to bring the striker 5 upwardly, while the second stopping portion 44 stops the unexpected movement of the striker 5, thus avoiding the unexpected opening of the front hood and improving the strength of the latch.

As shown in FIGS. 1-3, 5 and 6, the latch further includes an auxiliary locking member 7 provided on a side of the housing 1 away from the mounting portions 13 and pivotally supported on the housing 1 through the second shaft 71.

The auxiliary locking member 7 includes a locking portion 76 for locking the striker 5. The locking portion 76 is disposed outside the striker slot 11 and on a traveling path of the striker 5, and can be rotated between an auxiliary locking position where the striker 5 which exits from the striker slot 11 is locked, and an auxiliary unlocking position where the locking portion 76 is rotated away from the traveling path of the striker 5. The auxiliary locking member 7 is biased toward the auxiliary locking position by a spring 10.

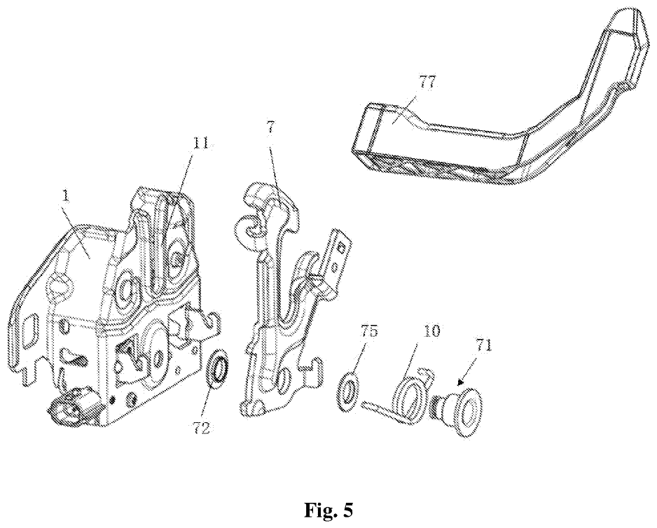

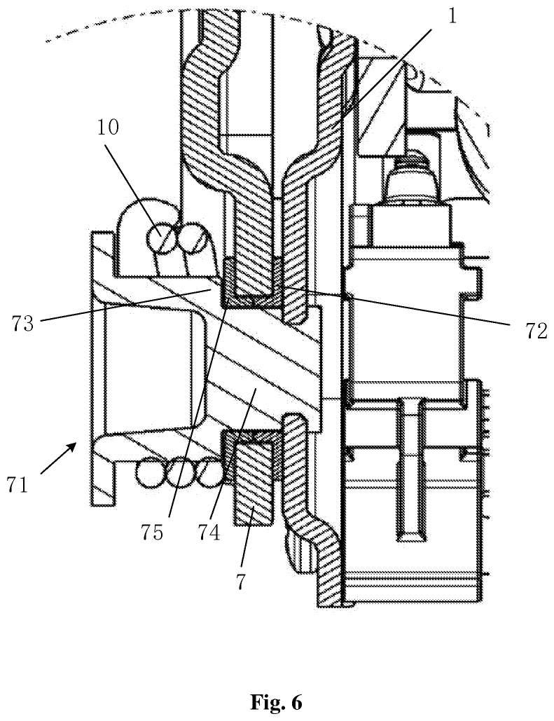

As shown in FIG. 5, an operating lever 77 is connected to the auxiliary locking member 7. By manipulating the operating lever 77, the auxiliary locking member 7 can be rotated toward the auxiliary unlocking position to release the striker. As shown in FIGS. 5 and 6, in the embodiment of the present disclosure, a first gasket 72 is provided between the auxiliary locking member 7 and the housing 1, to avoid non-smooth rotation of the auxiliary locking member 7 and wear of the auxiliary locking member and the housing caused by the entry of foreign contaminants such as dust into a gap between them.

As shown in FIG. 6, the second shaft 71 includes a main body 74 matched with a hole of the auxiliary locking member 7 and a step portion 73 projecting radially from the main body, wherein a second gasket 75 is also provided between the step portion 73 and the auxiliary locking member 7. The second gasket 75 further avoids non-smooth rotation of the auxiliary locking member 7 and wear of the auxiliary locking member and the second shaft caused by foreign contaminants such as dust entering the gap between the second shaft 71 and the auxiliary locking member 7.

The first gasket 72 and the second gasket 75 may have the same structure and may be constructed as an annular member with a flange. The flanges of the first gasket 72 and the second gasket 75 are both engaged between the auxiliary locking member 7 and the main body 74. An annular main body of the first gasket 72 is engaged between the auxiliary locking member 7 and the housing 1, and an annular main body of the second gasket 75 is engaged between the step portion 73 and the auxiliary locking member 7. The first gasket 72 and the second gasket 75, each designed as an annular member with an flange, fills radial and axial gaps between the second shaft 71 and the auxiliary locking member 7, and radial and axial gaps between the auxiliary locking member 7 and the housing 1, thus comprehensively reducing the risk of non-smooth movement and wear of related components caused by the entry of foreign contaminants such as dust.

Preferably, both the first gasket 72 and the second gasket 75 are made of self-lubricating materials, thus avoiding unsmooth operation of the auxiliary locking member 7, the second shaft 71 or the housing 1 caused by wear of grease or coating thereon, and avoiding the wear of related components. The self-lubricating material is a known material. Preferably, the first gasket 72 and the second gasket 75 are symmetrical in structure, so that it is not necessary to distinguish them during assembling, which is convenient for assembling, and non-smooth movement of the auxiliary locking member 7 due to asymmetric wear can be prevented.

Referring to FIGS. 1 to 6, an operation of the front hood latch will be described hereinafter in an exemplary manner.

First, as shown in FIG. 2, when closing the front hood, the striker 5, moved with the closing hood, abuts against the outer edge 761 of the locking portion 76 of the auxiliary locking member 7 disposed on the traveling path of the striker 5. As a result of the abutment of the striker 5 against the locking portion 76, the auxiliary locking member 7 is rotated in a counterclockwise direction in FIG. 2 towards the auxiliary unlocking position, out of the traveling path of the striker 5, thereby opening the striker slot 11 of the housing 1.

The striker 5 enters the opened striker slot 11, and further enters the locking groove 21 of the catch 2 which is in the unlocked position. Then, the striker 5 that has entered the locking groove 21 continues to move towards the bottom of the striker slot 11 and presses against the lower side wall of the locking groove 21, so that the catch 2 is rotated towards the locked position. Meanwhile, due to the pin 42 on the auxiliary catch 4 located in the hole 22, the catch 2 drives the auxiliary catch 4 so that they are rotated together towards the locked position as shown in FIG. 3.

As shown in FIG. 3, when the striker 5 reaches the bottom of the striker slot 11, the catch 2 is brought into the locked position. In the locked position, the first engaging portion 31 of the pawl 3 is engaged with the second engaging portion 23 of the catch 2, so that the catch 2 is locked by the pawl 3. The striker 5 is locked by the catch 2, that is to say, the front hood is kept in a completely closed state by the latch for the front hood.

Next, in the state that the front hood is kept completely closed, the auxiliary catch 4, under the action of the first spring 8, rotates towards the unlocked position (in the clockwise direction in FIG. 3) relative to the catch 2, so that the side wall 411 of the first stopping portion 41 protrudes into the locking groove 21. The side wall 411 of the stopping portion 41 abuts against the striker 5 from the lower side as shown in FIG. 3, and the upper wall of the locking groove 21 of the catch 2 abuts against the striker 5 from the upper side, thereby clamping the striker 5 therebetween. By clamping the striker 5 on opposite sides in the locked state, wobbling of the striker is prevented and noise generated by the wobbling can be eliminated.

Then, when opening the front hood, the pawl 3 is actuated to disengage the first engaging portion 31 of the pawl 3 from the second engaging portion 23 of the catch 2, so as to release the catch 2 from the locked position.

After the catch 2 is released, the force exerted by the first spring 8 on the auxiliary catch 4 is transmitted to the catch 2 via the pin 42 on the auxiliary catch 4, thereby rotating the catch 2 towards the unlocked position. Thus the striker 5 is pushed upwards by the catch 2 towards the open end of the striker slot 11 of the housing 1.

The striker 5 which is pushed upwards by the catch 2 is brought into abutment with an inner edge 762 of the locking portion 76 of the auxiliary locking member 7 which is disposed on the travelling path of the striker 5, whereby the striker 5 is stopped in the vicinity of the open end of the striker slot 11. The opening operation of the front hood is stopped temporarily, and the hood is popped up to a predetermined opening angle or an open position.

When the front hood is required to be completely opened, the operating lever 77 is operated manually, whereby the auxiliary locking member 7 is rotated towards the auxiliary unlocking position. The locking portion 76 is rotated out of the traveling path of the striker 5, whereby the striker slot 11 is opened. This allows the striker 5 to exit from the striker slot 11, whereby the hood is opened completely.

It should be pointed out that the above-mentioned embodiments should only be regarded to be exemplary, and the present disclosure is not limited to these embodiments. By considering the contents of the specification, those skilled in the art can make various changes and modifications without departing from the scope or spirit of the present disclosure. The real scopes of the present disclosure are defined by the appended claims and their equivalents.

1. A latch for a front hood of a vehicle, wherein, the latch is configured for locking or releasing the front hood by holding or releasing a striker attached to the front hood, the latch comprising:
a housing fixed to a vehicle body of the vehicle;
a catch rotatably supported on the housing and configured to lock the striker;
a pawl rotatably supported on the housing and configured to lock the catch;
an auxiliary catch rotatably supported on the housing, the auxiliary catch and the catch being configured to respectively abut against the striker on opposite sides in a locked state of the striker; and
a spacer provided between the auxiliary catch and the catch.

2. The latch according to claim 1,
wherein the housing includes a first shaft
wherein the spacer includes a first hole configured for the first shaft to pass through and
wherein the catch and the auxiliary catch are pivotally supported on the housing through the first shaft.

3. The latch according to claim 2,
wherein one of the catch and the auxiliary catch a projecting pin, and the other is-includes a corresponding hole configured to match with the pin, and
wherein the corresponding hole has an inner diameter larger than an outer diameter of the pin, and
wherein the spacer further includes a second hole for the pin to pass through.

4. The latch according to claim 1, further comprising an auxiliary locking member and a first gasket,
wherein the housing further includes a second shaft,
wherein the auxiliary locking member is pivotally supported on the housing through the second shaft, and
wherein the first gasket is arranged between the auxiliary locking member and the housing.

5. The latch according to claim 4, further comprising a second gasket,
wherein the auxiliary locking member includes a bole.
wherein the second shaft comprises a main body configured to match with the hole of the auxiliary locking member and a step portion projecting radially from the main body at a side away from the housing, and
wherein the second gasket is provided between the step portion and the auxiliary locking member.

6. The latch according to claim 5,
wherein the first gasket includes a first annular main body with a first flange and the second gasket includes a second annuler main body h a second flange,
wherein the first and second flange are engaged between the auxiliary locking member and the main body of the second shaft,
wherein the first annular main body of the first gasket is engaged between the auxiliary locking member and the housing, and
wherein the second annular main body of the second gasket is engaged between the step portion and the auxiliary locking member.

7. The latch according to claim 5, wherein the first gasket and the second gasket have the same structure.

8. The latch according to claim 5, wherein at least one of the first gasket and the second gasket is made of a self-lubricating material.

9. The latch according to claim 1, wherein the spacer is made of plastic.

10. The latch according to claim 1,
wherein the auxiliary catch comprises a first stopping portion and a second stopping portion located at opposite sides of the striker in the locked state of the striker, and
wherein the first stopping portion and the catch respectively abut against the striker on opposite sides.

11. The latch according to claim 10, wherein the second stopping portion of the auxiliary catch is configured to stop unexpected movement of the striker.

12. The latch according to claim 11, wherein the first stopping portion includes a side wall, and wherein the catch includes a locking groove.

13. The latch according to claim 12, wherein the side wall of the first stopping portion protrudes into locking groove of the catch in the locked state of the striker.
